(19) United States
(12) Patent Application Publication
(10) Pub. No.: US 2009/0153755 A1
(43) Pub. Date: Jun. 18, 2009

(54) RECORDING MEDIUM, IMAGE WRITING DEVICE, STORAGE MEDIUM IN WHICH IMAGE WRITING PROGRAM IS STORED, AND IMAGE WRITING METHOD

(75) Inventors: Hideo KOBAYASHI, Kanagawa (JP); Shigeru YAMAMOTO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/131,230

(22) Filed: Jun. 2, 2008

(30) Foreign Application Priority Data
Dec. 12, 2007 (JP) 2007-320871

(51) Int. Cl. G02F 1/135

(52) U.S. Cl. 349/29

(57) ABSTRACT

A recording medium is provided. The recording medium includes: a first display component that is configured by laminating at least a first photoconductive layer, a first display layer and a light blocking layer; and a second display component that is configured by laminating at least a second photoconductive layer and a second display layer. The light blocking layer is disposed between the first photoconductive layer and the first display layer. The second display component is joined together with the first display component such that the second photoconductive layer and the first photoconductive layer are in proximity to each other, and the second display component, in response to irradiation with light for image writing from the second display layer side, displays an image represented by that light for image writing.

### CROSS-REFERENCE TO RELATED APPLICATION

This application is based on and claims priority under 35 USC 119 from Japanese Patent Application No. 2007-320871 filed Dec. 12, 2007.

### BACKGROUND

1. Technical Field

The present invention relates to a recording medium, an image writing device, a storage medium in which an image writing program is stored, and an image writing method.

2. Related Art

Technologies relating to an optically writable recording medium on whose front side and back side are formed images represented by light for image writing have been disclosed.

### SUMMARY

According to an aspect of the invention, there is provided a recording medium comprising: a first display component that is configured by laminating at least a first photoconductive layer, a first display layer and a light blocking layer; and a second display component that is configured by laminating at least a second photoconductive layer and a second display layer, wherein the first photoconductive layer is disposed between a pair of first electrodes that are translucent, and the electrical resistance of the first photoconductive layer changes in response to light for image writing, the first display layer, in response to irradiation of the first photoconductive layer with the light in a state where a predetermined voltage is applied between the first electrodes, changes to a state where the first display layer displays an image corresponding to that light, and the first display layer maintains that state even when application of the predetermined voltage stops, the light blocking layer is disposed between the first photoconductive layer and the first display layer, the first display component, in response to irradiation with the light for image writing from the first photoconductive layer side, displays an image represented by that light for image writing, the second photoconductive layer is disposed between a pair of second electrodes that are translucent, and the electrical resistance of the second photoconductive layer changes in response to light for image writing, the second display layer, in response to irradiation of the second photoconductive layer with the light in a state where a predetermined voltage is applied between the second electrodes, changes to a state where the second display layer displays an image corresponding to that light, and the second display layer maintains that state even when application of the predetermined voltage stops, and the second display component is joined together with the first display component such that the second photoconductive layer and the first photoconductive layer are in proximity to each other, and the second display component, in response to irradiation with the light for image writing from the second display layer side, displays an image represented by that light for image writing.

### BRIEF DESCRIPTION OF THE DRAWINGS

An exemplary embodiment of the present invention will be described in detail based on the following figures, wherein:

FIG. 1 is a diagram showing the configuration of relevant components of an electrical system of an image writing device pertaining to the exemplary embodiment of the invention and a cross section of electronic paper;

FIG. 2 is a flowchart showing a flow of processing by an image writing program pertaining to the exemplary embodiment;

FIG. 3A and FIG. 3B are diagrams showing switching states of a switch component resulting from the image writing program pertaining to the exemplary embodiment;

FIG. 4A and FIG. 4B are diagrams showing timing charts of relevant components during execution of the image writing program pertaining to the exemplary embodiment; and

FIG. 5A and FIG. 5B are cross-sectional diagrams showing modifications of the electronic paper pertaining to the exemplary embodiment.

### DETAILED DESCRIPTION

Below, an exemplary embodiment of the present invention will be described with reference to the drawings. It will be noted that, in this exemplary embodiment, a case will be described where the present invention is applied to optically writable electronic paper on whose front side and back side are formed images as a result of being irradiated with light and an image writing device that writes an image by irradiating the electronic paper with light based on image information.

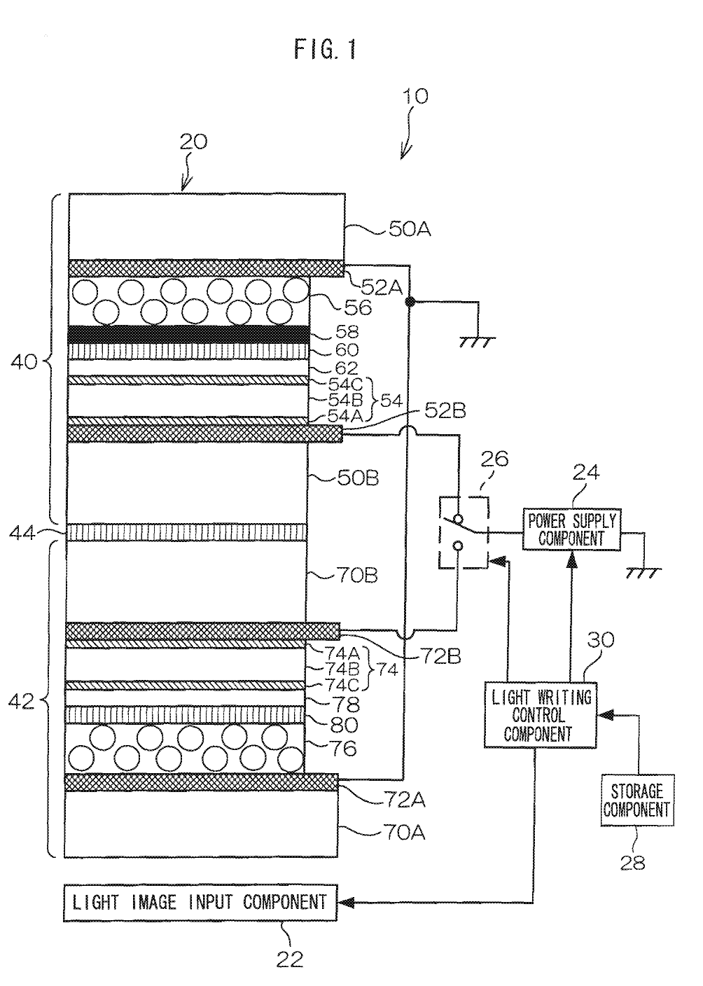

In FIG. 1, there is shown the configuration of relevant components of an electrical system of an image writing device 10 pertaining to the exemplary embodiment and a cross section of electronic paper 20.

The electronic paper 20 pertaining to the present exemplary embodiment is configured such that, in response to a voltage being applied to the electronic paper 20 and the electronic paper 20 being irradiated with light based on image information, images represented by that image information are displayed on the electronic paper 20. It will be noted that the electronic paper 20 pertaining to the present exemplary embodiment can maintain the displayed images even when application of the voltage is stopped.

The electronic paper 20 is formed as a result of a front side display component 40 (a first display component of the present invention) and a back side display component 42 (a second display component of the present invention) being joined together by an adhesive layer (a laminate layer) 44.

The front side display component 40 includes a substrate 50A, an electrode 52A (a first electrode of the present invention) that is translucent and disposed on the substrate 50A, a substrate 50B, and an electrode 52B (a first electrode of the present invention) that is translucent and disposed on the substrate 50B. Laminated between this pair of electrodes 52A and 52B are: a photoconductive layer 54 (a first photoconductive layer of the present invention) whose electrical resistance changes in response to light for image writing; a display layer 56 (a first display layer of the present invention) which, in response to irradiation of the photoconductive layer 54 with the light in a state where a predetermined voltage is applied between the pair of electrodes 52A and 52B, changes to a state where the display layer 56 displays an image corresponding to that light, and the display layer 56 maintains that state even when application of the predetermined voltage stops; and a light blocking layer 58 that is disposed between the photoconductive layer 54 and the display layer 56. In response to irradiation with the light for image writing from the photoconductive layer 54 side, the front side display component 40 displays an image represented by that light for image writing.

The substrates 50A and 50B are formed by polyethylene terephthalate (PET), which is translucent and has an insulating property. It will be noted that the substrates 50A and 50B may also be formed using an inorganic sheet such as glass or silicon, or a polymer film such as polysulfone, polyethersulfone, polycarbonate and polyethylene naphthalate. Here, the substrate 50B is joined together with the back side display component 42 via the adhesive layer 44.

Further, the pair of electrodes 52A and 52B are formed by indium tin oxide (ITO). It will be noted that, in addition to ITO, an electrical conductor such as a metal film of Au or the like or a film or the like of an oxide such as SnO₂ or ZnO or a conductive polymer such as a polypyrrole may also be used. Further, the electrode 52A pertaining to the present exemplary embodiment is sputtered and formed on the substrate 50A, and the electrode 52B pertaining to the present exemplary embodiment is sputtered and formed on the substrate 50B, but it is not invariably necessary for the electrode 52A and the electrode 52B to be formed by sputtering, and they may also be formed by printing, CVD, or vapor deposition. It will be noted that the electrode 52A is grounded to a ground via a wire connected thereto, the electrode 52B is connected to a later-described switch component 26, and the switch component 26 is switched to the electrode 52B side, whereby a voltage is applied to the electrode 52B.

Further, the photoconductive layer 54 absorbs light of a predetermined wavelength, and when the photoconductive layer 54 is irradiated with the light of the predetermined wavelength under an electric field formed in the photoconductive layer 54, a positive electric charge and a negative electric charge are generated by an internal photoelectric effect (photoelectric charge), this charge moves by the applied electric field, and a photoelectric current flows in the photoconductive layer 54. The generated quantity of the photoelectric charge depends on the intensity of the light, so the electrical resistance of the photoconductive layer 54 becomes smaller in response to the intensity of the light with which the photoconductive layer 54 is irradiated. It will be noted that light of a wavelength region to which the photoconductive layer 54 has light absorption sensitivity is used as the light with which the photoconductive layer 54 is irradiated.

Here, the photoconductive layer 54 pertaining to the present exemplary embodiment is capable of being driven by an alternating current because it has an internal photoelectric effect and its electrical resistance changes in response to the intensity of the light with which the photoconductive layer 54 is irradiated, and the photoconductive layer 54 has a three-layer structure that is formed by laminating a pair of charge generating layers (CGL) 54A and 54C so as to sandwich a charge transporting layer (CTL) 54B from above and below such that the photoconductive layer 54 is target-driven with respect to the light with which the photoconductive layer 54 is irradiated.

The display layer 56 has the function of modulating the reflected/transmitted state of light of a specific wavelength of incident light by the intensity of an electric field formed in the display layer 56, and has the property that the display layer 56 can hold the selected state under no electric field.

The display layer 56 pertaining to the present exemplary embodiment is configured by a liquid crystal layer of a self-holding liquid crystal complex comprising a cholesteric liquid crystal and a transparent resin. The cholesteric liquid crystal has the function of modulating the reflected/transmitted state of light of a specific wavelength of incident light, its liquid crystal molecules twist and orient in a helix, and the cholesteric liquid crystal interference-reflects light of a specific wavelength dependent on the helical pitch of light made incident from the helical axis direction. Moreover, the orientation of the cholesteric liquid crystal changes by the intensity of the electric field formed in the display layer 56, and the reflected state of incident light can be changed by this change in orientation. The cholesteric liquid crystal exhibits three reflection states: a focal conic orientation that is a state that transmits light; a planar orientation that is a state that selectively reflects light of a specific wavelength corresponding to the helical pitch; and a homeotropic orientation that is a state where the helical structure of the liquid crystal molecules completely unravels and all of the molecules follow the orientation of the electric field.

Of these three states, the planar orientation and the focal conic orientation can both stably exist under no electric field. Consequently, the states of the cholesteric liquid crystal are not unequivocally determined with respect to the intensity of the electric field formed in the display layer 56, and when the planar orientation is the initial state, the cholesteric liquid crystal changes in the order of the planar orientation, the focal conic orientation and the homeotropic orientation in accordance with an increase in the electric field intensity, and when the focal conic orientation is the initial state, the cholesteric liquid crystal changes in the order of the focal conic orientation and the homeotropic orientation in accordance with an increase in the electric field intensity. In the present exemplary embodiment, the initial state is when the state of the cholesteric liquid crystal is the focal conic orientation.

It will be noted that the cholesteric liquid crystal may also be combined with passive optical parts such as a deflection plate, an orientation retardation plate, or a reflection plate as assistance members that assist changes in the optical characteristics of the liquid crystal, and a dichroic pigment may also be added to the liquid crystal.

Here, the process by which an image is formed on the front side display component 40 as a result of the electronic paper 20 being irradiated with light will be described.

When a voltage is applied to the electrode 52B and the electronic paper 20 is irradiated with light, the resistance distribution serving as the electrical characteristic distribution of the photoconductive layer 54 changes in response to the light quantity of the light. Because of this change in the electrical resistance distribution of the photoconductive layer 54, the intensity of the electric field formed in the display layer 56 also resultantly changes, and the state of the cholesteric liquid crystal included in the display layer 56 becomes the homeotropic orientation in regard to the region irradiated with the light and becomes the focal conic orientation in regard to the region not irradiated with the light. In this state where the voltage is being applied to the cholesteric liquid crystal, light is transmitted, so an image that corresponds to the light with which the cholesteric liquid crystal is being irradiated cannot be seen, but by abruptly stopping application of the voltage, the region in the state of the homeotropic orientation changes to the state of the planar orientation, whereby the image can be seen by sunlight or light from a fluorescent lamp, for example.

Because of this change in the state of the cholesteric liquid crystal, an image that corresponds to the light with which the cholesteric liquid crystal has been irradiated is written on the display layer 56.

Further, between the photoconductive layer 54 and the display layer 56, the light blocking layer 58 is laminated on the display layer 56 side and an isolation layer 62 is laminated on the photoconductive layer 54 side, and the light blocking layer 58 and the isolation layer 62 are adhered to each other by an adhesive layer 60.

The light blocking layer 58 is a layer which, when the image that has been formed on the electronic paper 20 is seen, has the function of optically separating light reflected on the image that is seen and outside light made incident from the other side of the display side of the image that is seen to thereby prevent deterioration of the image quality of the image that is being displayed. The light blocking layer 58 is formed using, for example, a black color material (e.g., a coating material that includes a black dye or a black pigment such as carbon black or aniline black, or an inorganic material such as chromic oxide) that absorbs the entire visible wavelength region (400 mm to 700 mm), for example. Further, the color of the light blocking layer 58 represents the background color that is obtained as a result of light being transmitted through the display layer 56 and a display layer 76 (a second display layer of the present invention) of the later-described back side display component 42.

Further, the isolation layer 62 is formed by polyvinyl alcohol, for example, and isolates the photoconductive layer 54 and the display layer 56.

Similar to the front side display component 40, the back side display component 42 includes a substrate 70A, an electrode 72A (a second electrode of the present invention) that is translucent and disposed on the substrate 70A, a substrate 70B, and an electrode 72B (a second electrode of the present invention) that is translucent and disposed on the substrate 7013. Laminated between this pair of electrodes 72A and 72B are: a photoconductive layer 74 (a second photoconductive layer of the present invention) whose electrical resistance changes in response to light for image writing; and a display layer 76 which, in response to irradiation of the photoconductive layer 74 with the light in a state where a predetermined voltage is applied between the pair of electrodes 72A and 72B, changes to a state where the display layer 76 displays an image corresponding to that light, and the display layer 76 maintains that state even when application of the predetermined voltage stops. The back side display component 42 is joined together with the front side display component 40 such that the photoconductive layer 74 and the photoconductive layer 54 are in proximity to each other, and in response to irradiation with the light for image writing from the display layer 76 side, the back side display component 42 displays an image represented by that light for image writing.

The substrates 70A and 70B and the display layer 76 have the same configurations as those of the substrates 50A and 50B and the display layer 56 of the front side display component 40, and the substrate 700B is joined together with the front side display component 40 by the adhesive layer 44.

Further, the pair of electrodes 72A and 72B also have the same configuration as that of the pair of electrodes 52A and 52B of the front side display component 40. The electrode 72A is grounded to a ground via a wire connected thereto, the electrode 72B is connected to the later-described switch component 26, and the switch component 26 is switched to the electrode 72B side, whereby a voltage is applied to the electrode 72B.

Further, the photoconductive layer 74 also has, similar to the photoconductive layer 54 of the front side display component 40, a three-layer structure that is formed by laminating a pair of charge generating layers (CGL) 74A and 74C so as to sandwich a charge transporting layer (CTL) 74B from above and below.

Moreover, an isolation layer 78 is disposed between the photoconductive layer 74 and the display layer 76, and the display layer 76 and the isolation layer 78 are adhered to each other by an adhesive layer 80.

The image writing device 10 is configured to include a light image input component 22 (a light emitting component of the present invention), a power supply component 24, the switch component 26 (a switch component of the present invention), a storage component 28 and a light writing control component 30 (a control component of the present invention).

The light image input component 22 irradiates the electronic paper 20 with light for image writing based on image information. The wavelength of the light emitted from the light image input component 22 is a predetermined wavelength that can be absorbed by the photoconductive layer 54 and the photoconductive layer 74. It will be noted that the light image input component 22 is disposed such that its light-emitting surface faces the substrate 70A of the back side display component 42.

The power supply component 24 is connected to the switch component 26 and outputs a predetermined voltage to the switch component 26.

The switch component 26 switches the application destination of the predetermined voltage outputted from the power supply component 24 to the electrode 52B of the front side display component 40 or the electrode 72B of the back side display component 42. Additionally, the electrode 52B and the power supply component 24 become interconnected as a result of the switch component 26 being switched to the electrode 52B side, and the predetermined voltage outputted from the power supply component 24 is applied to the electrode 52B. Furthermore, the electrode 72B and the power supply component 24 become interconnected as a result of the switch component 26 being switched to the electrode 72B side, and the predetermined voltage outputted from the power supply component 24 is applied to the electrode 72B.

The storage component 28 is a memory that temporarily stores image information. It will be noted that, in the image writing device 10 pertaining to the present exemplary embodiment, a random access memory (RAM) is applied as the storage component 28, but the storage component 28 is not limited to this. For example, another semiconductor memory element such as an electrically erasable and programmable read-only memory (EEPROM) or a Flash EEPROM, a portable recording medium such as a flexible disk, a compact disc-recordable (CD-R) or a compact disc-rewritable (CD-RW), a hard disk drive (HDD) or an external storage device disposed in a server computer or the like connected to a network may also be applied as the storage component 28.

The light writing control component 30 is connected to the switch component 26 and the light image input component 22, performs control to switch the switch component 26 to the electrode 52B side when the light image input component 22 irradiates the electronic paper 20 with the light for image writing for causing an image to be displayed on the front side display component 40, and performs control to switch the switch component 26 to the electrode 72B side when the light image input component 22 irradiates the electronic paper 22 with the light for image writing for causing an image to be displayed on the back side display component 42.

Further, the light writing control component 30 is also connected to the storage component 28 and the power supply component 24, causes the light for image writing to be emitted from the light image input component 22 on the basis of the image information stored in the storage component 28, and controls the power supply component 24 to output the predetermined voltage.

It will be noted that the electronic paper 20 is capable of being carried separately from the image writing device 10.

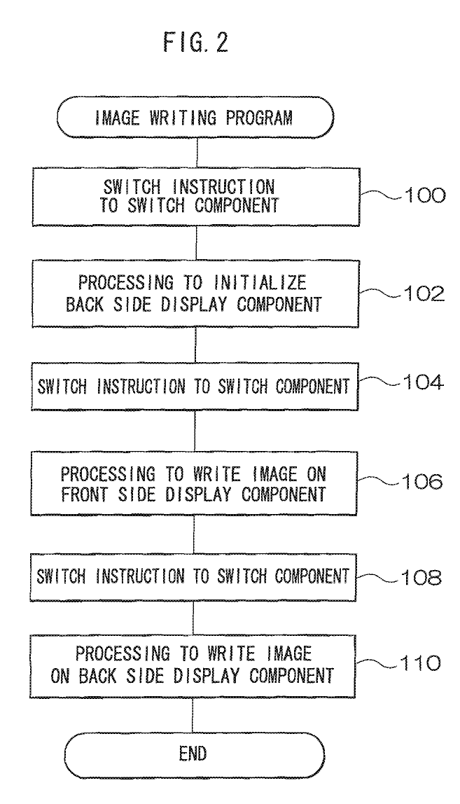

Next, the action of the image writing device 10 pertaining to the present exemplary embodiment will be described with reference to FIG. 2 to FIG. 4B.

FIG. 2 is a flowchart showing a flow of processing by an image writing program that is executed by the light writing control component 30 when the image writing device 10 receives an instruction to execute image writing with respect to the electronic paper 20. The program is stored in a predetermined region of the storage component 28.

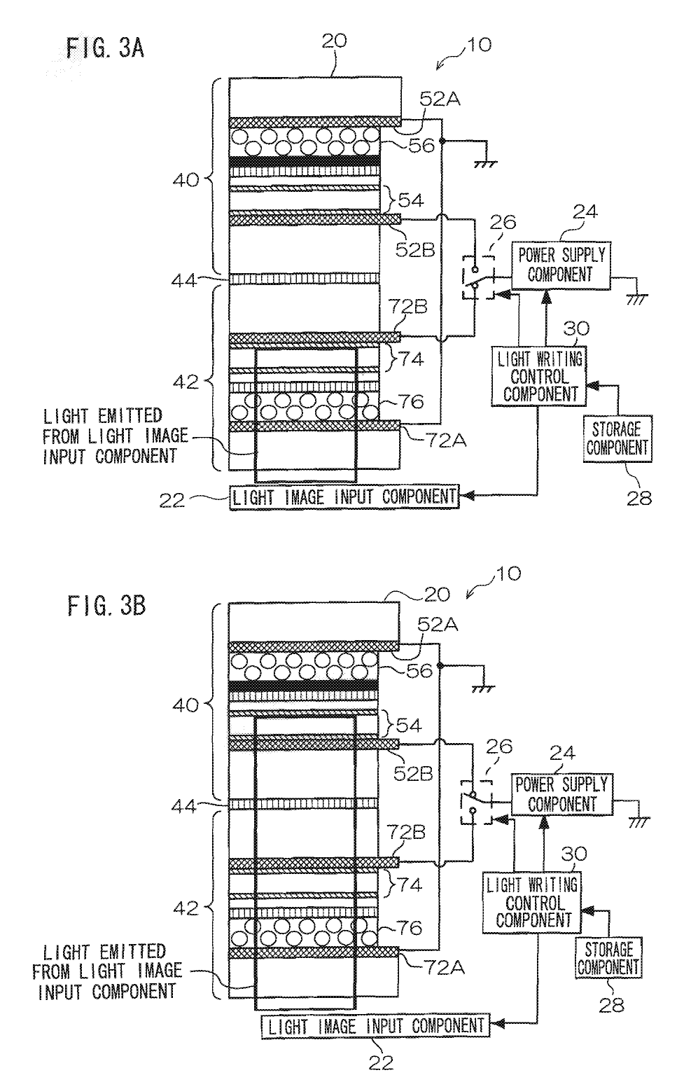

Further, FIG. 3A and FIG. 3B are diagrams showing switching states of the switch component resulting from the image writing program.

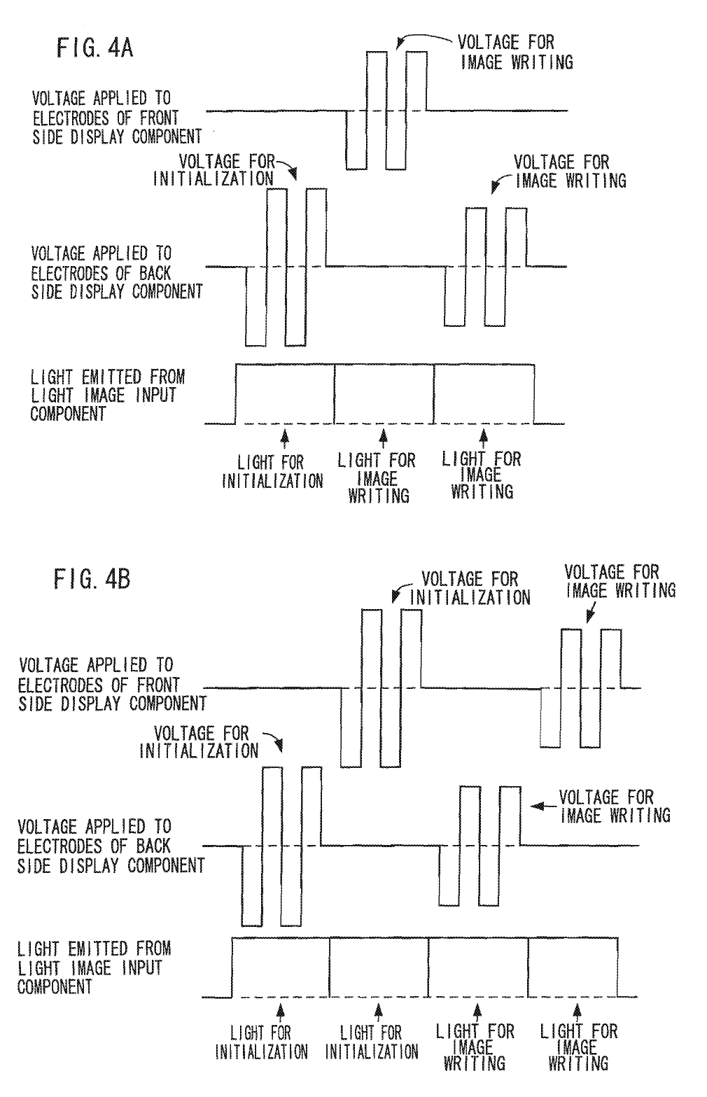

Moreover, FIG. 4A and FIG. 4B are diagrams showing timing charts of relevant components during execution of the image writing program.

In the flowchart shown in FIG. 2, first, in step 100, as shown in FIG. 3A, a switch instruction signal for switching the switch component 26 such that the electrode 72B of the back side display component 42 and the power supply component 24 become interconnected is outputted to the switch component 26.

In the next step 102, initialization processing that initializes the display state of the back side display component 42 is executed.

The initialization processing pertaining to the present exemplary embodiment causes a predetermined voltage for initialization to be outputted from the power supply component 24 and causes the entire display surface of the back side display component 42 to be irradiated with predetermined light for initialization from the light image input component 22. Thus, an electric field is formed between the pair of electrodes 72A and 7213 of the back side display component 42, and the resistance distribution serving as the electrical characteristic distribution of the photoconductive layer 74 changes in response to the light quantity of the light for initialization. Because of this change in the electrical resistance distribution of the photoconductive layer 74, the intensity of the electric field formed in the display layer 76 also resultantly changes in response to the light quantity of the light for initialization, and the cholesteric liquid crystal of the display layer 76 becomes the focal conic orientation that is the initial state. Because of this initialization processing, no image is displayed on the back side display component 42, and a drop in the light quantity of the light for image writing that is emitted from the light image input component 22 when writing an image on the front side display component 40 thereafter is prevented.

That is, as shown in the timing chart of FIG. 4A, the electronic paper 20 is irradiated with the light for initialization at a timing when the voltage for initialization is applied to the electrode 72B. The voltage for initialization is applied to the electrode 72B in a pulse manner with a predetermined frequency as a voltage where positive and negative are alternately inverted. It will be noted that the voltage level of the voltage for initialization is large in comparison to the voltage level of the voltage for image writing, but the voltage level of the voltage for initialization is not limited to this and may also be made the same size as the voltage for image writing as long as it is a voltage capable of allowing the cholesteric liquid crystal of the display layer 76 to become the focal conic orientation that is the initial state.

In step 104, as shown in FIG. 3B, a switch instruction signal for switching the switch component 26 such that the electrode 52B of the front side display component 40 and the power supply component 24 become interconnected is outputted to the switch component 26.

In the next step 106, image writing processing that writes an image on the front side display component 40 is executed.

The processing to write an image on the front side display component 40 pertaining to the present exemplary embodiment causes the voltage for image writing to be outputted from the power supply component 24, causes the image information representing an image to be displayed on the front side display component 40 to be read from the storage component 28, and causes the light for image writing based on that image information to be outputted from the light image input component 22. Thus, an electric field is formed between the pair of electrodes 52A and 52B of the front side display component 40, and the resistance distribution serving as the electrical characteristic distribution of the photoconductive layer 54 changes in response to the light quantity of the light for image writing. Because of this change in the electrical resistance distribution of the photoconductive layer 54, the intensity of the electric field formed in the display layer 56 also resultantly changes in response to the light quantity of the light for image writing, the orientation of the liquid crystal included in the display layer 56 changes as mentioned before, and an image based on the image information is displayed on the front side display component 40.

That is, as shown in the timing chart of FIG. 4A, the electronic paper 20 is irradiated with the light for image writing at a timing when the voltage for image writing is applied to the electrode 52B. Further, the voltage for image writing is applied to the electrode 52B in a pulse manner with a predetermined frequency as a voltage where positive and negative are alternately inverted.

In step 108, a switch instruction signal for switching the switch component 26 such that the electrode 72B of the back side display component 42 and the power supply component 24 become interconnected is outputted to the switch component 26.

In the next step 110, image writing processing that writes an image on the back side display component 42 is executed.

The processing to write an image on the back side display component 42 pertaining to the present exemplary embodiment causes the voltage for image writing to be outputted from the power supply component 24, causes the image information representing an image to be displayed on the back side display component 42 to be read from the storage component 28, and causes the light for image writing based on that image information to be outputted from the light image input component 22. Thus, similar to the processing to write an image on the front side display component 40 that is executed by step 106, an image is displayed on the back side display component 42, and the present program ends.

The present invention has been described above using the preceding exemplary embodiment, but the technical scope of the present invention is not limited to the scope described in the preceding exemplary embodiment. Various alterations or improvements can be added to the preceding exemplary embodiment in a range that does not depart from the gist of the invention, and embodiments to which those alterations or modifications have been added are also included in the technical scope of the present invention.

Further, the preceding exemplary embodiment is not intended to limit the inventions pertaining to the claims, and it is not the case that all combinations of features described in the preceding exemplary embodiment are essential to the solving means of the invention. Inventions of various stages are included in the preceding exemplary embodiment, and various inventions can be extracted by combinations of the plural configural requirements that are disclosed. As long as effects are obtained even when some configural requirements are omitted from all of the configural requirements described in the preceding exemplary embodiment, configurations from which those configural requirements have been omitted may be extracted as inventions.

For example, in the preceding exemplary embodiment, a case has been described where image writing processing was executed with respect to the front side display component 40 after initialization processing was executed with respect to the back side display component 42 and where image writing processing was thereafter executed with respect to the back side display component 42, but the present invention is not limited to this. For example, as shown in FIG. 4B, the invention may also be configured such that, between initialization processing with respect to the back side display component 42 and image writing processing with respect to the front side display component 40, control is executed such that the voltage is switched by the switch component 26 to the electrode 52B and the electronic paper 20 is irradiated by the light image input component 22 with light for initializing the display layer 56 (processing to initialize the front side display component 40), and thereafter processing to write an image on the front side display component 40 and processing to write an image on the back side display component 42 are executed. It will be noted that the processing to initialize the front side display component 40 is processing that is the same as the processing to initialize the back side display component 42.

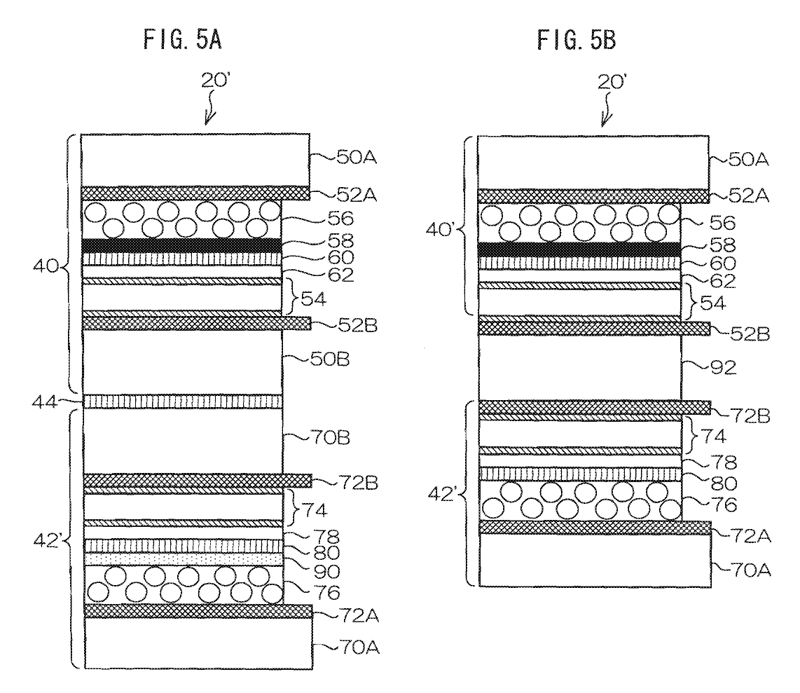

Further, in the preceding exemplary embodiment, a case has been described where the isolation layer 78 and the adhesive layer 80 are laminated between the photoconductive layer 74 and the display layer 76 of the back side display component 42, but the present invention is not limited to this. As shown in FIG. 5A, the invention may also be configured such that a photoselective transmissive layer 90 that selectively transmits light of a wavelength corresponding to the light for image writing is further laminated between the photoconductive layer 74 and the display layer 76 of the back side display component 42.

The photoselective transmissive layer 90 is configured to absorb or reflect at least some light in the visible light region or transmit just light of a wavelength region outside visible light (that is, infrared light) when a material that has light absorption sensitivity in regard to the wavelength region of infrared light, for example, is used as the photoconductive layer 74 and when light of the wavelength region of infrared light is used as the light emitted from the light image input component 22. In order to impart this characteristic to the photoselective transmissive layer 90, the photoselective transmissive layer 90 is formed by polyvinyl alcohol including a red color material (a red pigment, a red dye) and a black perylene pigment.

Additionally, the photoselective transmissive layer 90 of the above-described configuration is formed by administering a treatment to remove ions with respect to the above-described material (deionization) and thereafter using that material. For this deionization treatment, a publicly known technique is employed, such as a technique that utilizes an ion-exchange resin, a technique that utilizes a reverse osmosis membrane, a technique that utilizes electroseparation, and a technique that utilizes ultrafiltration. Thus, the ion concentration included in the photoselective transmissive layer 90 is reduced. As a result of the ion concentration being reduced, diffusion of ions from the photoselective transmissive layer 90 is reduced, and pollution of the adjacent display layer 76 resulting from this diffusion of ions is also controlled. For this reason, the affect on display characteristics with respect to the display layer 76 caused by ions included in the photoselective transmissive layer 90 is controlled, and a drop in the reflectivity of the display layer 76 when stored under a high temperature environment is controlled.

Further, in the preceding exemplary embodiment, a case has been described where the substrate 50B on which the electrode 52B of the front side display component 40 is formed and the substrate 70B on which the electrode 72B of the back side display component 42 is formed are adhered to each other via the adhesive layer 44, but the present invention is not limited to this. As shown in FIG. 5B, the invention may also be configured such that the electrode 52B of the front side display component 40 is formed on one side of a substrate 92 and the electrode 72B of the back side display component 42 is formed on the other side of the substrate 92.

Further, in the preceding exemplary embodiment, a case has been described where a cholesteric liquid crystal was applied as the liquid crystal material of the display layer 56, but the present invention is not limited to this. For example, the invention may also be configured such that a ferroelectric liquid crystal or the like is applied as the liquid crystal material of the display layer 56.

In addition, the configurations of the image writing device 10 and the electronic paper 20 that have been described in the preceding exemplary embodiment are only examples, and unnecessary components can be omitted and new components can be added within a range that does not depart from the gist of the present invention.

Further, the flow of processing by the image writing program (see FIG. 2) that has been described in the preceding exemplary embodiment is only an example, and unnecessary steps can be deleted, new steps can be added, and the processing order can be changed within a range that does not depart from the gist of the present invention.

Further, a case has been described where the image writing program pertaining to the preceding exemplary embodiment is installed beforehand in the storage component 28, but the image writing program can also be installed in the storage component 28 via a computer-readable recording medium or wired or wireless communication means.

What is claimed is:

1. A recording medium comprising:
a first display component that is configured by laminating at least a first photoconductive layer, a first display layer and a light blocking layer; and
a second display component that is configured by laminating at least a second photoconductive layer and a second display layer,
wherein
the first photoconductive layer is disposed between a pair of first electrodes that are translucent, and the electrical resistance of the first photoconductive layer changes in response to light for image writing,
the first display layer, in response to irradiation of the first photoconductive layer with the light in a state where a predetermined voltage is applied between the first electrodes, changes to a state where the first display layer displays an image corresponding to that light, and the first display layer maintains that state even when application of the predetermined voltage stops,
the light blocking layer is disposed between the first photoconductive layer and the first display layer,
the first display component, in response to irradiation with the light for image writing from the first photoconductive layer side, displays an image represented by that light for image writing,
the second photoconductive layer is disposed between a pair of second electrodes that are translucent, and the electrical resistance of the second photoconductive layer changes in response to light for image writing,
the second display layer, in response to irradiation of the second photoconductive layer with the light in a state where a predetermined voltage is applied between the second electrodes, changes to a state where the second display layer displays an image corresponding to that light, and the second display layer maintains that state even when application of the predetermined voltage stops, and
the second display component is joined together with the first display component such that the second photoconductive layer and the first photoconductive layer are in proximity to each other, and the second display component, in response to irradiation with the light for image writing from the second display layer side, displays an image represented by that light for image writing.

2. The recording medium of claim 1, wherein the first photoconductive layer and the second photoconductive layer are irradiated with the lights for image writing directed in the same direction.

3. The recording medium of claim 1, wherein in the second display component, a photoselective transmissive layer that selectively transmits light of a wavelength corresponding to the light for image writing is further laminated between the second photoconductive layer and the second display layer.

4. The recording medium of claim 3, wherein the photoselective transmissive layer includes a material to which a treatment for removing ions has been administered.

5. An image writing device that writes an image on a recording medium,
the recording medium including
a first display component that is configured by laminating at least a first photoconductive layer, a first display layer and a light blocking layer, and
a second display component that is configured by laminating at least a second photoconductive layer and a second display layer,
wherein
the first photoconductive layer is disposed between a pair of first electrodes that are translucent, and the electrical resistance of the first photoconductive layer changes in response to light for image writing,
the first display layer, in response to irradiation of the first photoconductive layer with the light in a state where a predetermined voltage is applied between the first electrodes, changes to a state where the first display layer displays an image corresponding to that light, and the first display layer maintains that state even when application of the predetermined voltage stops,
the light blocking layer is disposed between the first photoconductive layer and the first display layer,
the first display component, in response to irradiation with the light for image writing from the first photoconductive layer side, displays an image represented by that light for image writing,
the second photoconductive layer is disposed between a pair of second electrodes that are translucent, and the electrical resistance of the second photoconductive layer changes in response to light for image writing,
the second display layer, in response to irradiation of the second photoconductive layer with the light in a state where a predetermined voltage is applied between the second electrodes, changes to a state where the second display layer displays an image corresponding to that light, and the second display layer maintains that state even when application of the predetermined voltage stops, and
the second display component is joined together with the first display component such that the second photoconductive layer and the first photoconductive layer are in proximity to each other, and the second display component, in response to irradiation with the light for image writing from the second display layer side, displays an image represented by that light for image writing,
the image writing device comprising:
a light emitting component that irradiates the recording medium with light for image writing on the basis of image information;
a switch component that switches the application destination of the predetermined voltage to the first electrodes or the second electrodes; and
a control component that performs control to switch the switch component to the first electrodes side when the light emitting component irradiates the recording medium with the light for image writing for causing an image to be displayed on the first display component and performs control to switch the switch component to the second electrodes side when the light emitting component irradiates the recording medium with the light for image writing for causing an image to be displayed on the second display component.

6. The image writing device of claim 5, wherein when the image writing device is to write an image on the first display component and the second display component, the control component performs control such that
(a) the application destination of the predetermined voltage is switched by the switch component to the second electrodes and the recording medium is irradiated by the light emitting component with light for initializing the second display layer,
(b) after (a), the application destination of the predetermined voltage is switched by the switch component to the first electrodes and the recording medium is irradiated by the light emitting component with the light for image writing that corresponds to an image to be displayed on the first display layer,
(c) after (b), the application destination of the predetermined voltage is switched by the switch component to the second electrodes and the recording medium is irradiated by the light emitting component with the light for image writing that corresponds to an image to be displayed on the second display layer.

7. The image writing device of claim 6, wherein the control component performs control such that, between (a) and (b), the application destination of the predetermined voltage is switched by the switch component to the first electrodes and the recording medium is irradiated by the emitting component with light for initializing the first display layer.

8. The image writing device of claim 5, wherein in the second display component, a photoselective transmissive layer that selectively transmits light of a wavelength corresponding to the light for image writing is further laminated between the second photoconductive layer and the second display layer.

9. The image writing device of claim 8, wherein the photoselective transmissive layer includes a material to which a treatment for removing ions has been administered.

10. A storage medium readable by a computer, the storage medium storing a program of instructions executable by the computer to perform a function for writing an image on a recording medium,
the recording medium including
a first display component that is configured by laminating at least a first photoconductive layer, a first display layer and a light blocking layer, and
a second display component that is configured by laminating at least a second photoconductive layer and a second display layer,
wherein
the first photoconductive layer is disposed between a pair of first electrodes that are translucent, and the electrical resistance of the first photoconductive layer changes in response to light for image waiting,
the first display layer, in response to irradiation of the first photoconductive layer with the light in a state where a predetermined voltage is applied between the first electrodes, changes to a state where the first display layer displays an image corresponding to that light, and the first display layer maintains that state even when application of the predetermined voltage stops,
the light blocking layer is disposed between the first photoconductive layer and the first display layer,
the first display component, in response to irradiation with the light for image writing from the first photoconductive layer side, displays an image represented by that light for image writing,
the second photoconductive layer is disposed between a pair of second electrodes that are translucent, and the electrical resistance of the second photoconductive layer changes in response to light for image writing,
the second display layer, in response to irradiation of the second photoconductive layer with the light in a state where a predetermined voltage is applied between the second electrodes, changes to a state where the second display layer displays an image corresponding to that light, and the second display layer maintains that state even when application of the predetermined voltage stops, and
the second display component is joined together with the first display component such that the second photoconductive layer and the first photoconductive layer are in proximity to each other, and the second display component, in response to irradiation with the light for image writing from the second display layer side, displays an image represented by that light for image writing,
the function comprising:
(a) performing control such that the recording medium is irradiated with light for image writing on the basis of image information; and
(b) performing control such that, when the recording medium is to be irradiated with the light for image writing for causing an image to be displayed on the first display component by (a), a switch component that switches the application destination of the predetermined voltage to the first electrodes or the second electrodes is switched to the first electrodes side and performing control such that, when the recording medium is to be irradiated with the light for image writing for causing an image to be displayed on the second display component by (a), the switch component is switched to the second electrodes side.

11. The storage medium of claim 10, further comprising
when an image is to be written on the first display component and the second display component,
(c) performing control such that the application destination of the predetermined voltage is switched by the switch component to the second electrodes and the recording medium is irradiated with light for initializing the second display layer,
(d) after (c), performing control such that the application destination of the predetermined voltage is switched by the switch component to the first electrodes and the recording medium is irradiated with the light for image writing that corresponds to an image to be displayed on the first display layer, and
(e) after (d), performing control such that the application destination of the predetermined voltage is switched by the switch component to the second electrodes and the recording medium is irradiated with the light for image writing that corresponds to an image to be displayed on the second display layer.

12. The storage medium of claim 11, further comprising (f) performing control such that, between (c) and (d), the application destination of the predetermined voltage is switched by the switch component to the first electrodes and the recording medium is irradiated with light for initializing the first display layer.

13. A method of writing an image on a recording medium,
the recording medium including
a first display component that is configured by laminating at least a first photoconductive layer, a first display layer and a light blocking layer, and
a second display component that is configured by laminating at least a second photoconductive layer and a second display layer,
wherein
the first photoconductive layer is disposed between a pair of first electrodes that are translucent, and the electrical resistance of the first photoconductive layer changes in response to light for image writing,
the first display layer, in response to irradiation of the first photoconductive layer with the light in a state where a predetermined voltage is applied between the first electrodes, changes to a state where the first display layer displays an image corresponding to that light, and the first display layer maintains that state even when application of the predetermined voltage stops,
the light blocking layer is disposed between the first photoconductive layer and the first display layer,
the first display component, in response to irradiation with the light for image writing from the first photoconductive layer side, displays an image represented by that light for image writing,
the second photoconductive layer is disposed between a pair of second electrodes that are translucent, and the electrical resistance of the second photoconductive layer changes in response to light for image writing,
the second display layer, in response to irradiation of the second photoconductive layer with the light in a state where a predetermined voltage is applied between the second electrodes, changes to a state where the second display layer displays an image corresponding to that light, and the second display layer maintains that state even when application of the predetermined voltage stops, and
the second display component is joined together with the first display component such that the second photoconductive layer and the first photoconductive layer are in proximity to each other, and the second display component, in response to irradiation with the light for image writing from the second display layer side, displays an image represented by that light for image writing,
the method comprising:
(a) irradiating the recording medium with light for image writing on the basis of image information: and
(b) when the recording medium is to be irradiated with the light for image writing for causing an image to be displayed on the first display component by (a), switching a switch component that switches the application destination of the predetermined voltage to the first electrodes or the second electrodes to the first electrodes side, and when the recording medium is to be irradiated with the light for image writing for causing an image to be displayed on the second display component by (a), switching the switch component to the second electrodes side.
